(19) United States
(12) Patent Application Publication
(10) Pub. No.: US 2026/0079101 A1
(43) Pub. Date: Mar. 19, 2026

(54) APPARATUS FOR DETECTING NITROGEN DIOXIDE

(71) Applicants: The United States of America, as represented by the Secretary of Commerce, Silver Spring, MD (US); The Regents of the University of Colorado, a body corporate, Denver, CO (US)

(72) Inventors: Caroline Womack, Lafayette, CO (US); Rebecca Washenfelder, Boulder, CO (US); Steven Brown, Boulder, CO (US)

(21) Appl. No.: 18/209,062

(22) Filed: Jun. 13, 2023

Related U.S. Application Data
(60) Provisional application No. 63/351,521, filed on Jun. 13, 2022.

(51) Int. Cl. G01N 21/31; G01N 1/24

(52) U.S. Cl. CPC G01N 21/31; G01N 1/24; G01N 2201/0214; G01N 2201/0216; G01N 2201/062; G01N 2201/0636; G01N 2201/08

(57) ABSTRACT

Embodiments of the present invention relate to an apparatus for measuring nitrogen dioxide having components, pump and power consumption suitable for use with an UAV. Embodiments of the present invention also relate to an apparatus for measuring vertical profiles of ambient nitrogen dioxide having components, pump and power consumption suitable for use with a rotary wing UAV.

### CROSS-REFERENCE TO RELATED APPLICATION

This application claims the benefit of priority from U.S. Provisional Patent Application Ser. No. 63/351,521, filed on Jun. 13, 2022, the disclosure of which is incorporated herein by reference in its entirety.

### STATEMENT REGARDING FEDERAL RIGHTS

The invention described herein was made with United States Government support from the National Oceanic and Atmospheric Administration (NOAA), an agency of the United States Department of Commerce. The United States Government has certain rights in the invention.

### FIELD OF THE INVENTION

The present invention relates generally to an apparatus for trace gas detection, and more particularly, to an apparatus for the detection of nitrogen dioxide.

### BACKGROUND OF THE INVENTION

Accurate measurements of nitric oxide (NO) and nitrogen dioxide (NO₂) concentrations in the atmosphere are important because of their role in the photochemical production of ozone. Nitrogen oxides (NOx) are emitted in the troposphere primarily in the form of NO. NO reacts with ozone (O₃) to NO₂ and NO₂ is photolyzed to reconstitute the ozone. The rapid interconversion of NO and NO₂ occurs on a time scale of minutes. Nitrogen oxides are removed from the atmosphere by conversion to nitric acid. The dominant sink of NO₂ is its reaction with OH to form nitric acid. Characterizing NO₂ concentrations both horizontally and vertically is important due to its heterogeneous sources and sinks. Additionally, there is a need for in situ NO₂ measurements to validate remote sensing methods, particularly those available from geostationary satellites.

NO₂ measurement instruments with parts-per-trillion by volume (pptv) precision, accuracy of a few percent, linear response over two to three orders of magnitude, and a response time in seconds are needed for satellite validation, air quality monitoring, and atmospheric studies. Some field instruments that meet these criteria use laser-induced fluorescence, cavity ring-down spectroscopy, broadband cavity enhanced spectroscopy, or conversion to NO with subsequent detection by chemiluminescence or laser-induced fluorescence. UAVs can provide improved environmental sampling by allowing for better geographical and spatial coverage at a lower cost. However, the current implementations of these instruments are too large and heavy to be deployed onboard unmanned aerial vehicles (UAVs), and some have power consumption that exceeds what can be supplied by batteries. Even the largest UAVs have limited payloads compared to crewed aircraft and require lightweight instruments with low power consumption. Broadband cavity enhanced spectroscopy and cavity ring-down spectroscopy have potential for miniaturization. Although such smaller and lightweight electrochemical NO₂ sensors exist, they lack the desired precision and accuracy, and they can be affected by chemical interferences, relative humidity, and temperature.

Accordingly, there is need for a miniaturized NO₂ measurement apparatus having relatively simple and small set of required components, low power and pump requirements, and insensitivity to chemical interferences, and fluctuations in relative humidity, and temperature. In particular, there is a need for a miniaturized NO₂ measurement apparatus capable of being mounted small UAVs to measure ambient NO₂.

### SUMMARY OF THE INVENTION

Embodiments of the present invention relate to an apparatus for measuring nitrogen dioxide having components, pump and power consumption suitable for use with an UAV. Embodiments of the present invention also relate to an apparatus for measuring vertical profiles of ambient nitrogen dioxide having components, pump and power consumption suitable for use with a rotary wing UAV.

Accordingly, embodiments of the present invention relate to an apparatus for detecting nitrogen dioxide in an air sample, including an optical cavity comprising a bounded chamber configured to contain the air sample, wherein the optical cavity comprises an inlet for the air sample to enter the chamber and an outlet for the air sample to exit the chamber; a light source positioned to transmit light into the optical cavity chamber, wherein the transmitted light has a wavelength substantially overlapping an absorption wavelength of the nitrogen dioxide in the air sample; a parabolic mirror positioned to redirect the transmitted light from the light source into the optical cavity chamber; an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light; a detector positioned at the second end of the optical cavity to measure an attenuation in the output light, wherein the detector generates a digital signal in response to the attenuation in the output light; an optical frame for mounting the optical cavity, the light source, the parabolic mirror, the first mirror and the second mirror; a platform positioned on the optical frame for mounting the detector and a power source; a plurality of clamps positioned on the platform to attach the platform and the optical frame to an unmanned aerial vehicle; a pump for transporting the air sample into the optical cavity through the inlet, wherein the pump pulls the air sample at a predetermined flow rate to provide a predetermined residence time for the air sample in the optical cavity chamber; a plurality of sensors positioned to measure the ambient temperature, flow rate of the air sample, pressure and temperature inside the optical cavity chamber; a temperature controller for setting a thermoelectric cooler at a predetermined temperature; a power distributor for distributing power to the plurality of sensors, the temperature controller, the light source, the detector, and the pump; and a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the chamber pressure and the ambient temperature. More particularly, the light source comprises a light emitting diode emitting a light beam having a wavelength of about 457 nm and the detector comprises an optical sensor capable of detecting light having a wavelength from about 384 nm to about 499 nm.

Embodiments of the apparatus in accordance with the present invention further includes a light source driver for generating a predetermined current from the first portion of the power from the power source to the light source.

In one aspect of the present invention, the at least one of the plurality of sensors is a pressure sensor positioned downstream from the outlet to measure the pressure inside the chamber, wherein the at least one of the plurality of sensors is a flow sensor positioned downstream from the outlet to measure the flow rate of the air sample exiting the chamber through the outlet, and wherein the at least one of the plurality of sensors is a temperature sensor for measuring the temperature inside the optical cavity.

In another aspect of the present invention, the power distributor distributes a first portion of the power from the power source to the pressure sensor, the flow sensor and the temperature controller, and a second portion of the power from the power source to the light source, the detector, the pump, the temperature sensor and the thermoelectric cooler.

Embodiments of the apparatus in accordance with the present invention further include a filter positioned upstream from the inlet to remove aerosol particles in the air sample transported into the optical cavity.

Embodiments of the apparatus in accordance with the present invention also include a relay switch positioned to transmit an electrical signal from the temperature controller to the thermoelectric cooler, wherein the relay switch remains open until the thermoelectric cooler is set to the predetermined temperature.

In one embodiment of the present invention, the optical frame has a rectangular cage shape. More particularly, the optical frame comprises a plurality of rods and a plurality of plates positioned to form the rectangular cage, wherein each of the plurality of the rods is a hollow carbon fiber rods having an outer diameter of about 1.25 cm, and wherein each of the plurality of the plates is an aluminum plate having a thickness of about 0.76 cm.

In one embodiment of the present invention, the optical frame has a length of about 40 cm, width of about 10 cm and a height of about 10 cm.

In some embodiments of the present invention, the platform is an aluminum plate having a thickness of about 0.16 cm.

Another embodiment of the present invention relates to an apparatus for detecting nitrogen dioxide in an air sample, including an optical cavity comprising a bounded chamber configured to contain the air sample, wherein the optical cavity comprises an inlet for the air sample to enter the chamber and an outlet for the air sample to exit the chamber; a light source positioned to transmit light into the optical cavity chamber, wherein the transmitted light has a wavelength substantially overlapping an absorption wavelength of the nitrogen dioxide in the air sample; a parabolic mirror positioned to redirect the transmitted light from the light source into the optical cavity chamber; an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light; a detector positioned at the second end of the optical cavity to measure an attenuation in the output light, wherein the detector generates a digital signal in response to the attenuation in the output light; an optical frame for mounting the optical cavity, the light source, the parabolic mirror, the first mirror and the second mirror; a platform positioned on the optical frame for mounting the detector; a plurality of clamps positioned on the platform to attach the platform and the optical frame to an unmanned aerial vehicle; a pump for transporting the air sample into the optical cavity through the inlet, wherein the pump pulls the air sample at a predetermined flow rate to provide a predetermined residence time for the air sample in the chamber; a pressure sensor positioned downstream from the outlet to measure the pressure inside the chamber; a flow sensor positioned downstream from the outlet to measure flow rate of the air sample exiting the chamber through the outlet; a first temperature sensor for measuring a first temperature inside the optical cavity; a second temperature sensor positioned outside the optical cavity for measuring a second temperature; a temperature controller for setting a thermoelectric cooler at a predetermined third temperature; a power distributor for distributing a first portion of power from a power source to the pressure sensor, the flow sensor and the temperature controller, and a second portion of the power from the power source to a light source driver, the detector, the pump, the temperature sensor and the thermoelectric cooler, wherein the light source driver generates a predetermined current to the light source from the second portion of the power distributed from the power source; and a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the pressure measured by the pressure sensor and the second temperature measured by second temperature sensor.

In one aspect of the present invention, the light source includes a light emitting diode emitting a light beam having a wavelength of about 457 nm, and the detector includes an optical sensor capable of detecting light having a wavelength from about 384 nm to about 499 nm.

Embodiments of the apparatus in accordance with the present invention further includes a filter positioned upstream from the inlet to remove aerosol particles in the air sample transported into the optical cavity.

Embodiments of the apparatus in accordance with the present invention further includes a relay switch positioned to transmit an electrical signal from the temperature controller to the thermoelectric cooler, wherein the relay switch remains open until the thermoelectric cooler is set to the third temperature.

In one aspect of the present invention, the optical frame comprises a plurality of rods and a plurality of plates positioned to form a rectangular cage, wherein each of the plurality of the rods is a hollow carbon fiber rods having an outer diameter of about 1.25 cm, and wherein each of the plurality of the plates is an aluminum plate having a thickness of about 0.76 cm.

In one embodiment of the present invention, the optical frame has a length of about 40 cm, width of about 10 cm and a height of about 10 cm.

In some embodiments of the present invention, the platform is an aluminum plate having a thickness of about 0.16 cm.

Embodiments of the present invention also relate to an apparatus for detecting nitrogen dioxide in an air sample, including an optical cavity comprising a bounded chamber configured to contain the air sample, wherein the optical cavity comprises an inlet for the air sample to enter the chamber and an outlet for the air sample to exit the chamber; a light source positioned to transmit light into the optical cavity chamber, wherein the transmitted light has a wavelength of about 457 nm; a parabolic mirror positioned to redirect the transmitted light from the light source into the optical cavity chamber; an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light; a detector positioned at the second end of the optical cavity to measure an attenuation in the output light, wherein the detector generates a digital signal in response to the attenuation in the output light; an optical frame comprising a plurality of rods and a plurality of plates positioned to form a rectangular cage, wherein the optical cavity, the light source, the parabolic mirror, the first mirror and the second mirror are mounted on the optical frame; a platform positioned on the optical frame for mounting the detector and a power source; a plurality of clamps positioned on the platform to attach the platform and the optical frame to an unmanned aerial vehicle; a pump for transporting the air sample into the optical cavity through the inlet, wherein the pump pulls the air sample at a predetermined flow rate to provide a predetermined residence time for the sample air in the chamber; a filter positioned upstream from the inlet to remove aerosol particles in the air sample; a pressure sensor positioned downstream from the outlet to measure the pressure inside the chamber; a flow sensor positioned downstream from the outlet to measure flow rate of the air sample exiting the chamber through the outlet; a first temperature sensor for measuring a first temperature inside the optical cavity; a second temperature sensor positioned outside the optical cavity for measuring a second temperature; a temperature controller for setting a thermoelectric cooler at a predetermined third temperature; a power distributor for distributing a first portion of power from the power source to the pressure sensor, the flow sensor and the temperature controller, and a second portion of the power from the power source to a light source driver, the detector, the pump, the temperature sensor and the thermoelectric cooler, wherein the light source driver generates a predetermined current to the light source from the second portion of the power received from the power distributor; a relay switch positioned to transmit an electrical signal from the temperature controller to the thermoelectric cooler, wherein the relay switch transmits the electrical signal from the temperature controller to the thermoelectric cooler when the temperature of the thermoelectric cooler is below the third temperature; and a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the pressure measured by the pressure sensor and the second temperature measured by second temperature sensor.

### BRIEF DESCRIPTION OF DRAWINGS

FIG. 1 illustrates an exemplary layout of a NO₂ detection apparatus in accordance with an embodiment of the present invention.

FIG. 2 illustrates a schematic view of an optical system of a NO₂ detection apparatus in accordance with an embodiment of the present invention.

FIG. 3 illustrates an alternate view of an exemplary layout of a NO₂ detection apparatus in accordance with an embodiment of the present invention.

FIG. 4 illustrates an exemplary mounting system of a NO₂ detection apparatus in accordance with an embodiment of the present invention.

FIG. 5 illustrates a schematic view of a flow system of a NO₂ detection apparatus in accordance with an embodiment of the present invention.

FIG. 6 illustrates a schematic view of a data acquisition system of a NO₂ detection apparatus in accordance with an embodiment of the present invention

FIG. 7 illustrates an exemplary vertical profile of NO₂ measured using during ascent and descent of a UAV flight with NO₂ detection apparatus in accordance with an embodiment of the present invention.

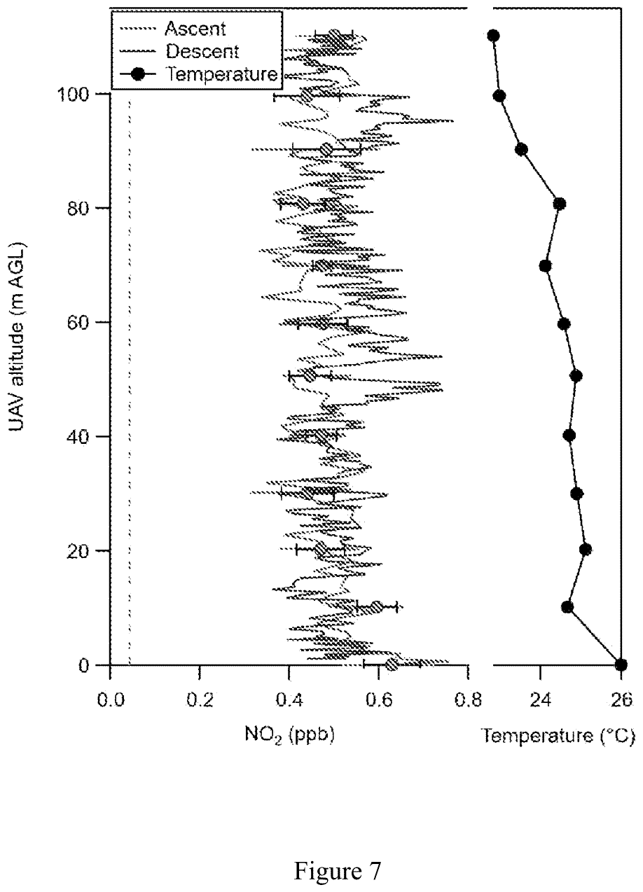

FIG. 8 illustrates an exemplary correlation plot showing measurements of NO₂ standards obtained using NO₂ detection apparatus in accordance with an embodiment of the present invention.

FIG. 9 illustrates an exemplary deviation plot of optical extinction zero air measurements and a deviation plot of fitted NO₂.

### DETAILED DESCRIPTION

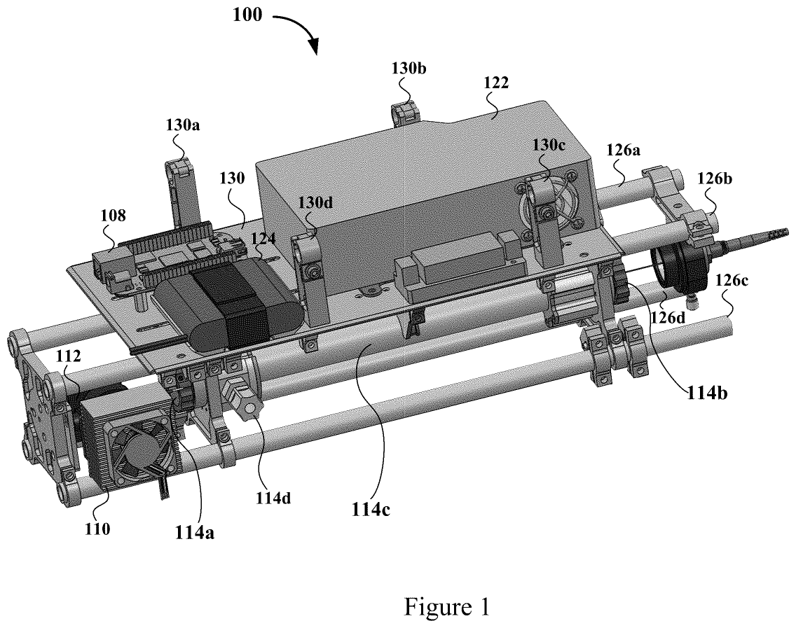

Referring now to the drawings, and more particularly, to FIGS. 1 through 6, there is shown an apparatus for the detection of NO₂ in atmosphere, generally designated 100, which comprises embodiments of the present invention. NO₂ detection apparatus 100 includes optical system 102, flow system 104, UAV mounting system 106, and data acquisition system 108.

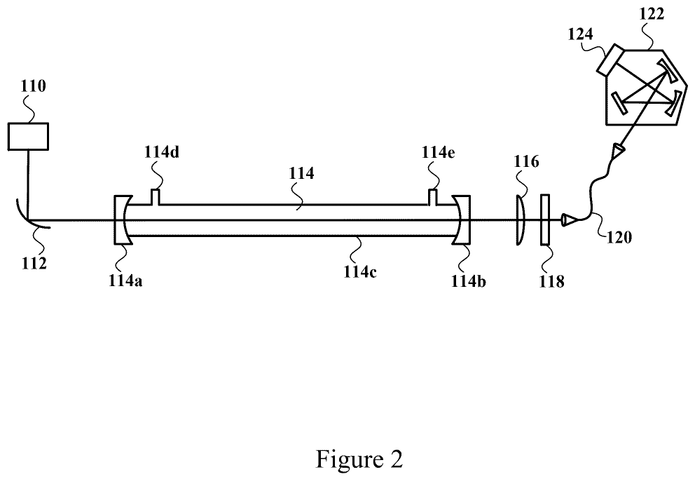

FIG. 2 shows an exemplary layout of NO₂ detection apparatus 100 illustrating components of optical system 102. Components of optical system 102, as shown in FIG. 2, includes a light source 110, an off-axis parabolic mirror 112, an optical cavity 114, collection lens 116, a bandpass filter 118, an optical fiber 120, and a grating spectrometer 122, and a detector 124.

Light source 110 provides a light beam having a predetermined wavelength. In one embodiment of the present invention, light source 110 is a light emitting diode (LED) having a wavelength centered at 457 nm with full-width at half-maximum of 15 nm powered by a constant-current power supply (3.7 VDC at 1.0 A) and temperature-controlled at 22.5±0.05 deg C. using a thermoelectric cooler.

Off-axis parabolic mirror 112 collects the light beam from light source 110 and redirects the collected light beam into optical cavity 114. In one embodiment of the present invention, off-axis parabolic mirror 112 has an effective focal length of about 2.0 cm. Optical cavity 114 includes a rear mirror 114a, a front mirror 114b, and a sample cell 114c. Optical cavity 114 is formed between rear mirror 114a and front mirror 114b. In one embodiment of the present invention, optical cavity 114 is a linear cavity having a length of about 22.3 cm. Rear mirror 114a and front mirror 114b are placed parallel to each other to form an optical resonator so that light can be reflected back and forth between mirrors 114a and 114b along an optical axis. In one embodiment of the present invention, each of rear mirror 114a and front mirror 114b is a curved mirror having a 1 m radius of curvature with measured reflectivity of about 0.999963 at about 450 nm. Rear mirror 114a is located at the proximal end of optical cavity 114 and is configured to allow redirected light beam from off-axis parabolic mirror 112 to enter optical cavity 114. Front mirror 114b is positioned at the distal end of optical cavity 114, as further shown in FIG. 2, and transmits output light beam from optical cavity 114.

The light beam entering optical cavity 114 through rear mirror 114a travels through the length of optical cavity 114 and is reflected back and forth between rear mirror 114a and front mirror 114b to form an oscillating light beam inside optical cavity 114. Multiple reflections of light beam between rear mirror 114a and front mirror 114b increases the effective optical extinction path length in cavity 114.

Sample cell 114c provides an optional enclosure or housing (not shown) for an airtight seal of optical cavity 114 such as to allow control of the environment within the housing and hence optical cavity 114. In one embodiment of the present invention, sample cell 114c is made from PTFE tubing having an internal diameter of about 1.90 cm. In some embodiments of the present invention, sample cell 114c provides a cavity having a volume of about 63 cm³, resulting in a sample residence time of about 2.5 s when the flow rate is set to 1.5 lpm. Sample cell 114c includes a sample inlet 114d and a sample outlet 114e located facing each other on the surface of sample cell 114c such that a longitudinal axis traversing the centers of inlet 114d and outlet 114e is perpendicular to the longitudinal axis traversing the center of sample cell 114c. In one embodiment of the present invention, inlet 114d and outlet 114e are Teflon fittings. Cell inlet 114d allows gas sample to enter sample cell 114c, fill the cavity of sample cell 114c and exit sample cell 114c via cell outlet 114e. The light beam propagating through sample cell 114c interacts with gas flowing into sample cell 114c via cell inlet 114d to generate an output light beam including an attenuation caused by the interaction of the light beam with gas in sample cell 114c. Front mirror 114b transmits the output light beam from optical cavity 114. Collection lens 116 couples the output light beam into optical fiber 120. Bandpass filter 118 is positioned between collection lens 116 and optical fiber 120 to eliminate stray light. In one embodiment of the present invention, bandpass filter 118 has a center wavelength of about 452 nm and a full-width half maximum (FWHM) bandwidth of about 50.5 nm.

Optical fiber 120 transmits the coupled output light beam to grating spectrometer 122. In one embodiment of the present invention, optical fiber 120 is a circular optical fiber having a length of about 1 m. Grating spectrometer 122 disperses the output light into a spectrum of light. Detector 124 records the spectrum of light from grating spectrometer 122, detects the attenuation in the output light in the form of an optical signal and converts the optical signal to an electrical signal. In one embodiment of the present invention, detector 124 includes 1024×58 array of pixels with 18-bit analog-to-digital conversion (ADC), and a 200 μm wide entrance slit, and acquires spectra at about 0.15 seconds intervals spanning a region from about 384.3 nm to about 499.9 nm with a FWHM resolution of about 0.9 nm across the entire spectral region. Detector 124 includes an analog-to-digital converter to convert the electrical signal to a digital signal. The digital signal from detector 124 is transmitted to data acquisition system 108.

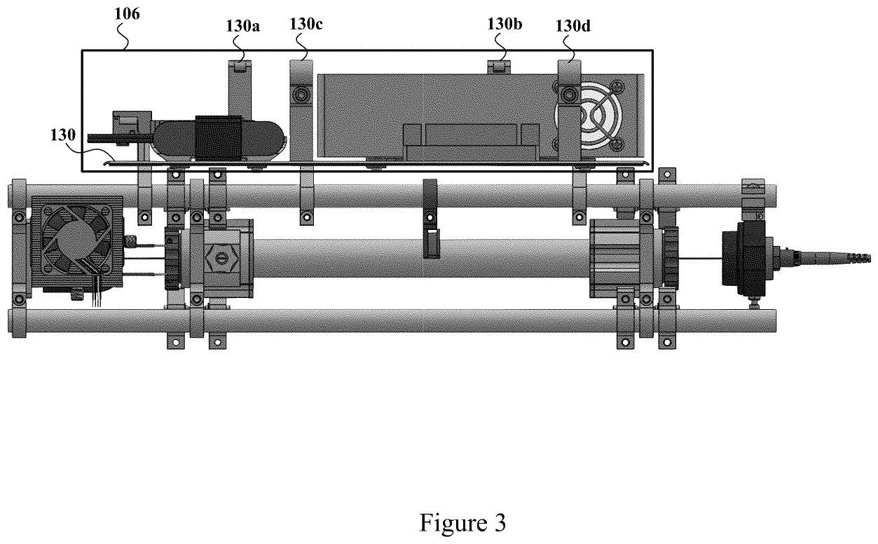

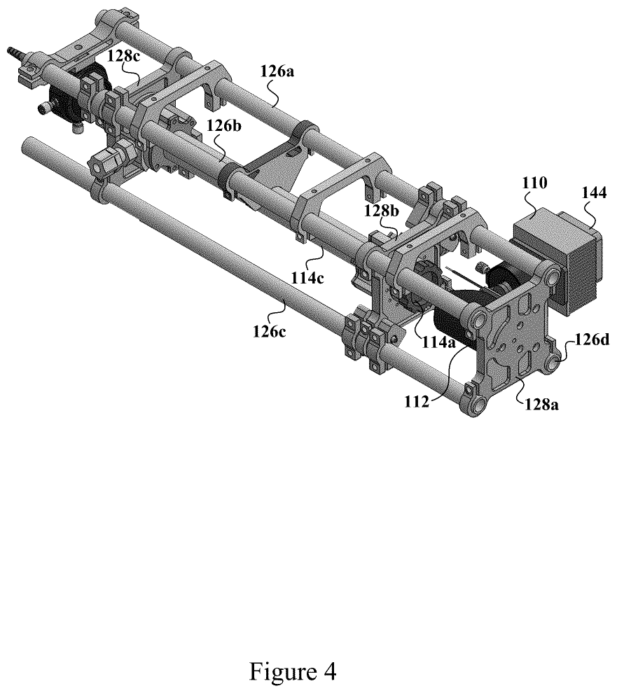

Light source 110, off-axis parabolic mirror 112, rear mirror 114a, front mirror 114b, and sample cell 114c of optical system 102 are supported by four rods 126a-d and three mounting plates 128a-c positioned to form an optical frame having a rectangular cage shape, as shown in FIGS. 3 and 4. In one embodiment of the present invention, rods 126a-d are hollow carbon fiber rods having an outer diameter of about 1.25 cm and plates 128a-b are aluminum plates having a thickness of about 0.76 cm. Plates 128a-c are aligned parallel to each other and locked into position by rods 126a-d positioned on each corner of plates 128a-b such that rods 126a-d are parallel to each other, as further shown in FIG. 4. In one embodiment of the present invention, plates 128a-c are secured to rods 126a-d using split clamp mounts. In one embodiment of the present invention, the optical frame formed by rods 126a-d and plates 128a-b have a length of about 40 cm, width of about 10 cm and a height of about 10 cm. Plate 128b is positioned at the proximal end of sample cell 114c and includes an opening to receive the proximal end of sample cell 114c, and plate 128c is positioned at the distal end of sample cell 114c and includes an opening to receive the distal end of sample cell 114c. Plate 128b receiving the proximal end of sample cell 114c and plate 128c receiving the distal end of sample cell 114c positions sample cell 114c at the center of the optical frame formed by mounting system 106.

The optical frame formed by rods 126a-d and plates 128a-b further includes mounts for each of light source 110, off-axis parabolic mirror 112, rear mirror 114a, front mirror 114b, and sample cell 114c of optical system 102. The mounts include mechanically adjustable clamps to position and secure the mounts on rods 126a-d. Rear mirror 114a is mounted on the opposite face of plate 128b, positioned to be in contact with the proximal end of sample cell 114c through the opening in plate 128b and sealed at the contact point using a compression seal. Rear mirror 114a is vertically positioned such that the optical axis of rear mirror 114a aligns with the optical axis of sample cell 114c. Front mirror 114b is mounted on the opposite face of plate 128c, positioned to be in contact with the distal end of sample cell 114c through the opening in plate 128c and sealed at the contact point using a compression seal. Front mirror 114b is vertically positioned such that the optical axis of front mirror 114b aligns with the optical axis of sample cell 114c. Light source 110 and off-axis parabolic mirror 112 are mounted on plate 128a and positioned to align with rear mirror 114a such that off-axis parabolic mirror 112 collects the light beam from light source 110 and redirects the collected light beam into optical cavity 114 through rear mirror 114a.

UAV mounting system 106 includes a platform 130 mounted to top rods 126a and 126b and above the optical frame, as shown in FIG. 1. In one embodiment of the present invention, platform 130 is an aluminum plate having a thickness of about 0.16 cm. Grating spectrometer 122 and detector 124 are secured to platform 130. Platform 130 further includes four clamps 130a-d for securing NO₂ detection apparatus 100 to an UAV. In one embodiment of the present invention, NO₂ detection apparatus 100 can be mounted on to a DJI Matrice 600 Pro UAV using clamps 130a-d. UAV mounting system allows for the high-precision NO₂ instrument to be mounted under a UAV without being subject any negative effects of flight, such as vibrations and rapid changed in movement. It also may be configured in a number of ways to suit other UAV platforms, including fixed wing UAVs for longer flight times, without any changes to the functionality of the instrument.

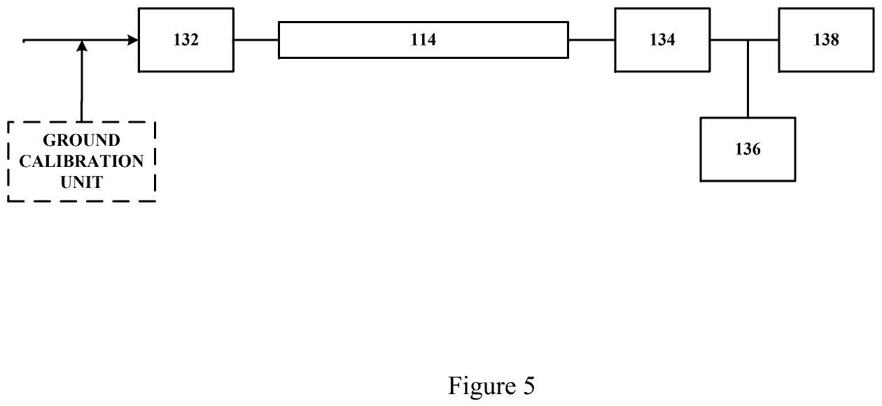

Flow system 104 includes a filter 132, optical cavity 114, pressure sensor 134, flow sensor 136, and pump 138, as shown in FIG. 5. Pump 138 pulls sample air at a constant flow rate into optical cavity 114 through inlet 114d of sample cell 114c to provide a predetermined residence time for sample air in sample cell 114c. In one embodiment of the present invention, pump 138 is a mini-diaphragm pump capable of pulling sample air at a flow rate of 1.4 lpm at 840 mbar to provide a residence time of about 2.5 seconds in sample cell 114c. Filter 132 is positioned upstream from inlet 114d of sample cell 114c to remove aerosol particles in air sample entering optical cavity 114. In one embodiment of the present invention, filter 132 is a single-stage filter assembly with replaceable 0.45 μm pore polytetrafluoroethylene (PTFE) filters. Pressure sensor 134 and flow sensor 136 are positioned downstream from outlet 114e of sample cell 114c to measure sample cell 114c pressure and flow rate of sample air exiting sample cell 114c through outlet 114e. In one embodiment of the present invention, pressure sensor 134 is a miniature pressure sensor with a precision of about 7 mbar in 1 second. In another embodiment of the present invention, flow sensor 136 is a miniature flow sensor that is calibrated to measure sample air flow rate from about 0 lpm to about 2.0 lpm.

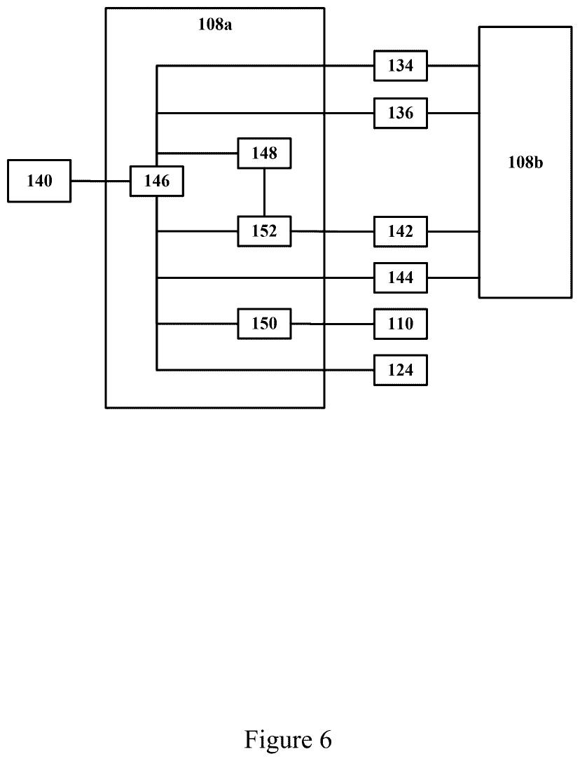

Data acquisition system 108 includes a power distributor 108a for distributing power from a power source 140 to light source 110, detector 124, pressure sensor 134, flow sensor 136, pump 138, temperature sensor 142 and thermoelectric cooler 144 to cool light source 110, as shown in FIG. 6. In one embodiment of the present invention, power source 140 is a 14.7 V, 2200 mAh rechargeable Li Ion battery. Power distributor 108a includes a voltage divider circuit 146 to divide and generate multiple voltage levels from a common voltage source. Power distributor 108a distributes a first portion of the divided voltage to pressure sensor 134, flow sensor 136 and a temperature controller 148, and distributes a second portion of the divided voltage to light source 110 via a light source driver 150, detector 124, pump 138, temperature sensor 142 and thermoelectric cooler 144 via a relay switch 152. Light source driver 150 provides a constant output current from the first portion of the divided voltage distributed from power source 140. First portion of the divided voltage distributed to temperature controller 148 is used to set the temperature of thermoelectric cooler 144 via relay switch 152. Relay switch 152 is ‘ON’ up to a set temperature and cuts ‘OFF’ above the set temperature. As the temperature of thermoelectric cooler 144 drops, relay switch 152 is switched ‘ON’ at a temperature slightly lower than the set point.

Data acquisition system 108 also includes a processor 108b, as further shown in FIG. 6, to acquire analog and digital measurements from a first temperature sensor 142a measuring temperature inside cavity 114, a second temperature sensor 142b measuring ambient temperatures, pressure sensor 134 measuring the pressure inside cavity 114, and flow sensor 136 measuring flow rate of sample air exiting cavity 114. Processor 108b determines density and light extinction inside cavity 114. Processor 108b determines density inside cavity 114 from the digital signal received from detector 124, the pressure measured by pressure sensor 134 and the ambient temperature measured by second temperature sensor 142b mounted outside cavity 114.

Processor 108b determines the light extinction in cavity 114, αₑₓₜ(λ), using the following equation (1) and determines the concentrations of NO₂ by nonlinear least-square fitting of the cavity extinction αₑₓₜ(λ). Processor 108b utilizes the temperature and pressure of the air sample measured inside cavity 114 to determine the number of air molecules per cubic centimeter and utilizes this information to convert the determined number of NO2 molecules per cubic centimeter from the non-linear least squares fitting into ppb (the standard unit).

$${α}_{ext} ( λ ) = ( \frac{1 - R ( λ )}{d} + {α}_{Ray , Za} ( λ ) ) ( \frac{{I}_{Z A} ( λ ) - {I}_{sample} ( λ )}{{I}_{sample} ( λ )} ) + Δ {α}_{Ray} ( λ ) \qquad ( 1 )$$

where λ is the wavelength of light, dis the cavity length, R(λ) is the mirror reflectivity, α_{Ray,ZA}(λ) is the Rayleigh scattering of zero air, I_{ZA}(λ) is the reference spectrum of zero air, and Iₛₐₘₚₗₑ(λ) is the measured spectrum of ambient air. The term Δα_{Ray}(λ) is equal to Δα_{Ray,ZA}(λ)−Δα_{Ray,sample}(λ), and accounts for pressure differences between the Rayleigh scattering of the reference zero air spectrum, I_{ZA}(λ), acquired on the ground and the sample spectrum, Iₛₐₘₚₗₑ(λ), acquired on the UAV. α_{Ray,ZA}(λ) and Δα_{Ray}(λ) in equation (1) are determined by taking the Rayleigh scattering cross section of a given gas and multiplying it by the density of air.

The mirror reflectivity, R(λ), in Equation (1) can be determined using standard additions of known extinction. In one embodiment, mirror reflectivity R(λ) can be determined using known Rayleigh scattering of helium and zero air. These are added sequentially while NO₂ detection apparatus 100 is on the ground, using compressed helium and zero air with a mass flow controller to overflow cavity 114 via inlet 114d.

The measured extinction, αₑₓₜ(λ), is equal to the sum of the contributing extinctions:

$${α}_{ext} ( λ ) = {\sum }_{i}^{n} {σ}_{i} ( λ ) {N}_{i} + p ( λ ) \qquad ( 2 )$$

where σᵢ(λ) and Nᵢ are the absorption cross section and number density of the ith gas-phase absorber and p(λ) is a 4^{th}-order polynomial that encompasses the broad features in the measured extinction that can be attributed to drifts in the light source intensity, pressure, and spectrometer optics. Values of σᵢ(λ) can be taken from high-resolution reference cross sections for CHOCHO, H₂O, and O₄ and convolved to the spectrometer resolution. To improve the quality of the spectral fit, a reference spectrum for σ_{NO2}(λ) can be regularly determined by standard addition of a small amount of NO₂ into cavity 114. This reference spectrum can alternatively be used in the spectral fitting, which minimizes the residual features in the fit. Further, this reference spectrum can be used to fine-tune the spectrometer wavelength calibration, and to determine the degree to which known spectra need to be convolved to match the spectrometer's spectral resolution. Levenberg-Marquardt least squares linear fitting can be used to for the spectral fitting to determine Nᵢ and σ(λ) in Equation (2). The fit can be optimized between 430 and 476.5 nm and a wavelength-dependent weighting factor can be used to prioritize the fit in the spectral region where the mirror reflectivity is highest.

A standardized sampling sequence is followed during typical operation of NO₂ detection apparatus 100 during UAV flights. First, NO₂ detection apparatus 100 is attached to the UAV's expansion mounting kit using clamps 130a-d. NO₂ detection apparatus 100 is then powered on and a dark background spectra is recorded with the light source off.

Using the ground calibration unit, as shown in FIG. 5, helium and zero air are sequentially flowed into optical cavity 114 through inlet 114d of sample cell 114c followed by NO₂ in zero air to provide NO₂ reference spectra for Equation (2). In one embodiment, helium and zero air are flowed into optical cavity 114 through inlet 114d of sample cell at a rate of 2 lpm for about 15 seconds followed by about 100 ppb NO₂ in zero air to provide NO₂ reference spectra. NO₂ detection apparatus 100 is disconnected from the ground calibration unit before UAV flight. A sampling pattern including vertical profiles is used during operation of NO₂ detection apparatus 100 in UAV flight. When sample air containing trace amounts of NO₂ is pulled into cavity 114 by pump 138, the NO₂ molecules absorb light at certain wavelengths that is specific and unique to the NO₂ molecule, often referred to as a spectral fingerprint. Detector 124 monitors attenuations in the light reaching detector 124, and processor 108b correlates the attenuations in the light with the concentration of NO₂ in cavity 114. Following the UAV flight sequence, NO₂ detection apparatus 100 is again connected to the ground calibration unit to repeat the helium and zero air measurements. Data can be transferred from data acquisition system 108 also for offline spectral fitting and data analysis. UAV batteries can be replaced when multiple UAV flights are required.

Reference now to the specific examples which follow will provide a clearer understanding of systems in accordance with embodiments of the present invention. The examples should not be construed as a limitation upon the scope of the present invention.

### Example. NO₂ Detection Apparatus Operation Onboard Matrice 600 Pro UAV

NO₂ detection apparatus was attached to the mounting kit of Matrice 600 Pro UAV using four clamps. The NO₂ detection apparatus was powered on and a dark background spectrum was recorded with the LED off. Using a ground calibration unit shown in FIG. 5, the optical cavity of the NO₂ detection apparatus was sequentially overflowed via the inlet with 2 lpm of helium and zero air for 15 s each, followed by another overflow with about 100 ppbv of NO₂ in zero air to provide a NO₂ reference spectra. The apparatus was disconnected the ground calibration unit for flight after calibration. A sampling pattern was applied during the operation of the NO₂ detection apparatus in UAV flight. The sampling pattern included vertical profiles ascending from about 0 m to about 120 m, with 10 s hovering at a constant altitude after each 10 m ascent. The vertical descent was continuous at 0.5 m s⁻¹. This sequence requires approximately 7 min, such that a single UAV flight can include three vertical profiles for a total flight time of 21 min (25% battery power margin for the UAV). FIG. 6 shows the vertical profile of NO₂ from 0-120 m above ground level measured by the NO₂ detection apparatus near the NOAA David Skaggs Research Center in Boulder, Colorado (39.9905 deg N, 105.2629 deg W) between 11:30 am-12:00 pm local time (MDT) on 26 May 2022. FIG. 6 also shows the 0.15 s spectral data averaged to 1 s, and the average and standard deviation for each 10 s period at constant altitude. The corresponding temperature profiles are also shown in FIG. 6.

The vertical NO₂ measurements indicate that the boundary layer height exceeded 120 m with well-mixed NO₂ concentrations, as expected for mid-day measurements acquired away from local point sources. Measured NO₂ concentrations varied between 0.4 ppbv and 0.6 ppbv. With a measurement precision of 43 pptv NO₂ in 1 s, the observed variability within the vertical profile represents real NO₂ variation. The reflectivity measurements at the beginning and end of the test flight were 0.999954 and 0.999953 at 450 nm, indicating that the optical alignment of the NO₂ detection apparatus was stable and unaffected by the vibration of the UAV.

The accuracy of NO₂ detection apparatus was evaluated by propagating the component uncertainties from Equation (1). These include the uncertainty in the Rayleigh scattering cross-section of zero air (±2%), pressure (±0.1%), temperature (±0.7%), and absorption cross-section of NO₂ (±4%). The contribution of the Rayleigh scattering cross-section of He is negligible. Summing these errors in quadrature gives a total calculated uncertainty of ±4.5% for NO₂.

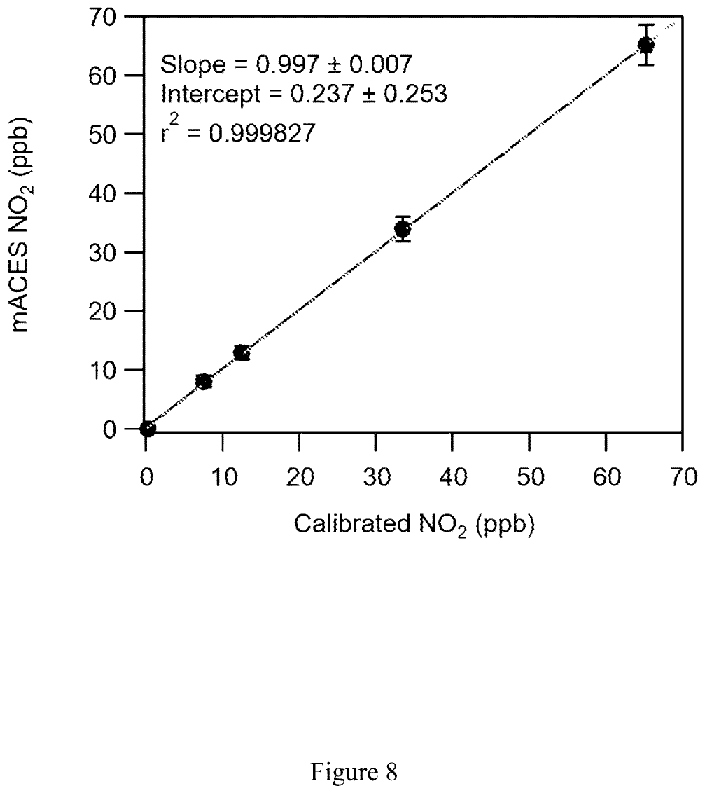

The accuracy of NO₂ detection apparatus was also evaluated by comparison to standard additions of NO₂. O₃ concentrations were generated and measured by a O₃ monitor and subsequently reacted with an excess of 3 ppmv NO to quantitatively convert O₃ to NO₂ which was measured by NO₂ detection apparatus in accordance with embodiments of the present invention. FIG. 8 shows a correlation plot for NO₂ concentrations ranging from 0-70 ppb acquired for 1 min each. The slope is 0.997±0.007 and the intercept is 0.237±0.253 pptv. The r2 value is 0.999827, indicating an agreement between the NO₂ standard additions and measurements obtained using the NO₂ detection apparatus.

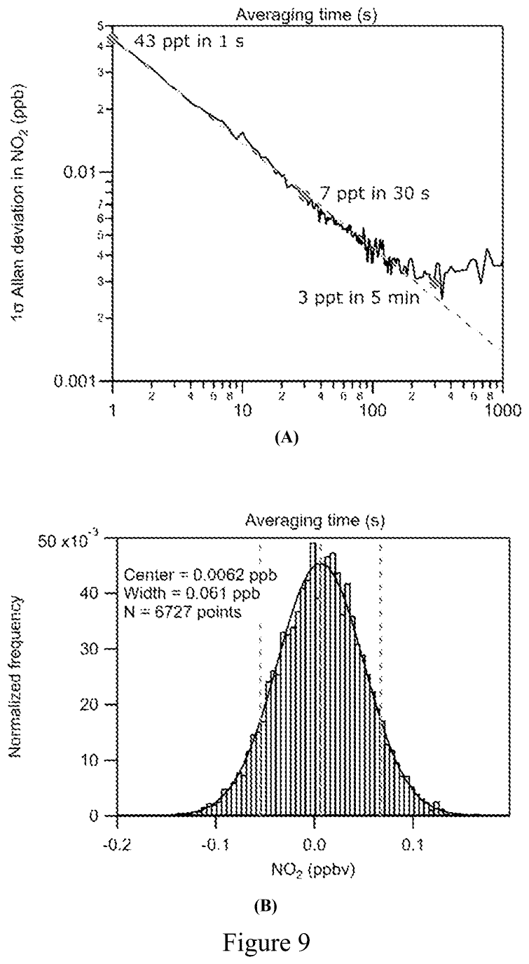

NO₂ detection apparatus precision was evaluated by measuring zero air in the laboratory over 2 h, with measurements of mirror reflectivity, spectrometer dark counts, and the NO₂ reference spectrum at the start of the measurement period. Deviation plots were calculated for both the optical extinction and retrieved NO₂ concentrations, to quantify the precision and drift as a function of time. FIG. 9 show the deviation for the optical extinction and retrieved NO₂ concentrations. The calculated precision (1σ) of the optical extinction was 7.69×10⁻¹⁰ cm⁻¹ at 1 sand 3.54×10⁻¹⁰ cm⁻¹ at 30 s. The calculated precision (1σ) of the retrieved NO₂ is 43 pptv at 1 s and 7 pptv at 30 s. Both the accuracy and precision are sufficient for tropospheric measurements of NO₂.

Apparatus in accordance with embodiments of the present invention has several advantages over previous NO₂ detection apparatus. NO₂ detection apparatus in accordance with embodiments of the present invention is smaller than any other NO₂ measurement technique with similar precision. NO₂ detection apparatus in accordance with embodiments of the present invention is more precise than current small, low cost NO₂ sensors and has high specificity to NO₂ due to the unique spectral fingerprint of NO₂ when illuminated with light. NO₂ detection apparatus in accordance with embodiments of the present invention is not subject to common interference effects from environmental factors such as relative humidity, and it can be mounted on a UAV or many other lightweight platforms to measure NO₂ with high accuracy and precision in areas where it has never been measured before.

An instrument with this accuracy, precision, size, and weight can be used onboard small UAVs, as well as balloon sondes and being deployed as a distributed network for low-cost monitoring. NO₂ detection apparatus in accordance with embodiments of the present invention could be deployed together with a selected set of miniature gas, aerosol, or meteorological sensors for vertical sampling and atmospheric characterization. Further, NO₂ detection apparatus in accordance with embodiments of the present invention can be modified to measure different target analytes. Changing the LED, high-finesse cavity mirrors, bandpass filter, and spectrometer grating of NO₂ detection apparatus would change the spectral region of NO₂ detection apparatus and allow different target analytes to be measured. These include the detection of nitrous acid, formaldehyde, sulfur dioxide, nitrate radical, aerosol extinction, and other species using broad band cavity enhanced spectroscopy.

NO₂ detection apparatus in accordance with embodiments of the present invention can be adapted to a variety of configurations suitable for selective gas detection. Construction of apparatus, as described herein, provides flexibility to vary the shape of NO₂ detection apparatus to fit specific spaces. It is thought that NO₂ detection apparatus of the present invention and many of its attendant advantages will be understood from the foregoing description and it will be apparent that various changes may be made in the form, construction arrangement of parts thereof without departing from the spirit and scope of the invention or sacrificing all of its material advantages, the form hereinbefore described being merely a preferred or exemplary embodiment thereof.

Those familiar with the art will understand that embodiments of the invention may be employed, for various specific purposes, without departing from the essential substance thereof. The description of any one embodiment given above is intended to illustrate an example rather than to limit the invention. This above description is not intended to indicate that any one embodiment is necessarily preferred over any other one for all purposes, or to limit the scope of the invention by describing any such embodiment, which invention scope is intended to be determined by the claims, properly construed, including all subject matter encompassed by the doctrine of equivalents as properly applied to the claims.

What is claimed is:

1. An apparatus for detecting nitrogen dioxide in an air sample, said apparatus comprising:
an optical cavity comprising a bounded chamber configured to contain the air sample, wherein the optical cavity comprises an inlet for the air sample to enter the chamber and an outlet for the air sample to exit the chamber;
a light source positioned to transmit light into the optical cavity chamber, wherein the transmitted light has a wavelength substantially overlapping an absorption wavelength of the nitrogen dioxide in the air sample;
a parabolic mirror positioned to redirect the transmitted light from the light source into the optical cavity chamber;
an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light;
a detector positioned at the second end of the optical cavity to measure an attenuation in the output light, wherein the detector generates a digital signal in response to the attenuation in the output light;
an optical frame for mounting the optical cavity, the light source, the parabolic mirror, the first mirror and the second mirror;
a platform positioned on the optical frame for mounting the detector and a power source;
a plurality of clamps positioned on the platform to attach the platform and the optical frame to an unmanned aerial vehicle;
a pump for transporting the air sample into the optical cavity through the inlet, wherein the pump pulls the air sample at a predetermined flow rate to provide a predetermined residence time for the air sample in the optical cavity chamber;
a plurality of sensors positioned to measure the ambient temperature, flow rate of the air sample, pressure and temperature inside the optical cavity chamber;
a temperature controller for setting a thermoelectric cooler at a predetermined temperature;
a power distributor for distributing power to the plurality of sensors, the temperature controller, the light source, the detector, and the pump; and
a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the chamber pressure and the ambient temperature.

2. The apparatus of claim 1, wherein the light source comprises a light emitting diode emitting a light beam having a wavelength of about 457 nm.

3. The apparatus of claim 1, wherein the detector comprises an optical sensor capable of detecting light having a wavelength from about 384 nm to about 499 nm.

4. The apparatus of claim 1, further comprising a light source driver for generating a predetermined current from the first portion of the power from the power source to the light source.

5. The apparatus of claim 1, further comprising a filter positioned upstream from the inlet to remove aerosol particles in the air sample transported into the optical cavity.

6. The apparatus of claim 1, further comprising a relay switch positioned to transmit an electrical signal from the temperature controller to the thermoelectric cooler, wherein the relay switch remains open until the thermoelectric cooler is set to the predetermined temperature.

7. The apparatus of claim 1, wherein the at least one of the plurality of sensors is a pressure sensor positioned downstream from the outlet to measure the pressure inside the chamber, wherein the at least one of the plurality of sensors is a flow sensor positioned downstream from the outlet to measure the flow rate of the air sample exiting the chamber through the outlet, and wherein the at least one of the plurality of sensors is a temperature sensor for measuring the temperature inside the optical cavity.

8. The apparatus of claim 7, wherein the power distributor distributes a first portion of the power from the power source to the pressure sensor, the flow sensor and the temperature controller, and a second portion of the power from the power source to the light source, the detector, the pump, the temperature sensor and the thermoelectric cooler.

9. The apparatus of claim 1, wherein the optical frame has a rectangular cage shape.

10. The apparatus of claim 9, wherein the optical frame comprises a plurality of rods and a plurality of plates positioned to form the rectangular cage, wherein each of the plurality of the rods is a hollow carbon fiber rods having an outer diameter of about 1.25 cm, and wherein each of the plurality of the plates is an aluminum plate having a thickness of about 0.76 cm.

11. The apparatus of claim 9, wherein the optical frame has a length of about 40 cm, width of about 10 cm and a height of about 10 cm.

12. The apparatus of claim 1, wherein the platform is an aluminum plate having a thickness of about 0.16 cm.

13. An apparatus for detecting nitrogen dioxide in an air sample, said apparatus comprising:
an optical cavity comprising a bounded chamber configured to contain the air sample, wherein the optical cavity comprises an inlet for the air sample to enter the chamber and an outlet for the air sample to exit the chamber;
a light source positioned to transmit light into the optical cavity chamber, wherein the transmitted light has a wavelength substantially overlapping an absorption wavelength of the nitrogen dioxide in the air sample;
a parabolic mirror positioned to redirect the transmitted light from the light source into the optical cavity chamber;
an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light;
a detector positioned at the second end of the optical cavity to measure an attenuation in the output light, wherein the detector generates a digital signal in response to the attenuation in the output light;
an optical frame for mounting the optical cavity, the light source, the parabolic mirror, the first mirror and the second mirror;
a platform positioned on the optical frame for mounting the detector;
a plurality of clamps positioned on the platform to attach the platform and the optical frame to an unmanned aerial vehicle;
a pump for transporting the air sample into the optical cavity through the inlet, wherein the pump pulls the air sample at a predetermined flow rate to provide a predetermined residence time for the air sample in the chamber;
a pressure sensor positioned downstream from the outlet to measure the pressure inside the chamber;
a flow sensor positioned downstream from the outlet to measure flow rate of the air sample exiting the chamber through the outlet;
a first temperature sensor for measuring a first temperature inside the optical cavity;
a second temperature sensor positioned outside the optical cavity for measuring a second temperature;
a temperature controller for setting a thermoelectric cooler at a predetermined third temperature;
a power distributor for distributing a first portion of power from a power source to the pressure sensor, the flow sensor and the temperature controller, and a second portion of the power from the power source to a light source driver, the detector, the pump, the temperature sensor and the thermoelectric cooler, wherein the light source driver generates a predetermined current to the light source from the second portion of the power distributed from the power source; and
a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the pressure measured by the pressure sensor and the second temperature measured by second temperature sensor.

14. The apparatus of claim 13, wherein the light source comprises a light emitting diode emitting a light beam having a wavelegth of about 457 nm, and wherein the detector comprises an optical sensor capable of detecting light having a wavelength from about 384 nm to about 499 nm.

15. The apparatus of claim 1, further comprising a filter positioned upstream from the inlet to remove aerosol particles in the air sample transported into the optical cavity.

16. The apparatus of claim 1, further comprising a relay switch positioned to transmit an electrical signal from the temperature controller to the thermoelectric cooler, wherein the relay switch remains open until the thermoelectric cooler is set to the third temperature.

17. The apparatus of claim 9, wherein the optical frame comprises a plurality of rods and a plurality of plates positioned to form a rectangular cage, wherein each of the plurality of the rods is a hollow carbon fiber rods having an outer diameter of about 1.25 cm, and wherein each of the plurality of the plates is an aluminum plate having a thickness of about 0.76 cm.

18. The apparatus of claim 9, wherein the optical frame has a length of about 40 cm, width of about 10 cm and a height of about 10 cm.

19. The apparatus of claim 1, wherein the platform is an aluminum plate having a thickness of about 0.16 cm.

20. An apparatus for detecting nitrogen dioxide in an air sample, said apparatus comprising:
an optical cavity comprising a bounded chamber configured to contain the air sample, wherein the optical cavity comprises an inlet for the air sample to enter the chamber and an outlet for the air sample to exit the chamber;
a light source positioned to transmit light into the optical cavity chamber, wherein the transmitted light has a wavelength of about 457 nm;
a parabolic mirror positioned to redirect the transmitted light from the light source into the optical cavity chamber;
an optical resonator formed by a first mirror positioned on a first end of the optical cavity and a second mirror positioned on a second end of the optical cavity, wherein the redirected light from the parabolic mirror is transmitted into the optical cavity chamber through the first mirror, wherein the light transmitted into the optical cavity chamber is reflected between the first and the second mirrors to form an oscillating light beam, wherein at least a first portion of the oscillating light beam is transmitted out of the optical cavity chamber through the second mirror as an output light;
a detector positioned at the second end of the optical cavity to measure an attenuation in the output light, wherein the detector generates a digital signal in response to the attenuation in the output light;
an optical frame comprising a plurality of rods and a plurality of plates positioned to form a rectangular cage, wherein the optical cavity, the light source, the parabolic mirror, the first mirror and the second mirror are mounted on the optical frame;
a platform positioned on the optical frame for mounting the detector and a power source;
a plurality of clamps positioned on the platform to attach the platform and the optical frame to an unmanned aerial vehicle;
a pump for transporting the air sample into the optical cavity through the inlet, wherein the pump pulls the air sample at a predetermined flow rate to provide a predetermined residence time for the sample air in the chamber;
a filter positioned upstream from the inlet to remove aerosol particles in the air sample;
a pressure sensor positioned downstream from the outlet to measure the pressure inside the chamber;
a flow sensor positioned downstream from the outlet to measure flow rate of the air sample exiting the chamber through the outlet;
a first temperature sensor for measuring a first temperature inside the optical cavity;
a second temperature sensor positioned outside the optical cavity for measuring a second temperature;
a temperature controller for setting a thermoelectric cooler at a predetermined third temperature;
a power distributor for distributing a first portion of power from the power source to the pressure sensor, the flow sensor and the temperature controller, and a second portion of the power from the power source to a light source driver, the detector, the pump, the temperature sensor and the thermoelectric cooler, wherein the light source driver generates a predetermined current to the light source from the second portion of the power received from the power distributor;
a relay switch positioned to transmit an electrical signal from the temperature controller to the thermoelectric cooler, wherein the relay switch transmits the electrical signal from the temperature controller to the thermoelectric cooler when the temperature of the thermoelectric cooler is below the third temperature; and
a processor for determining the amount of the nitrogen dioxide in the air sample, wherein the processor determines the amount of the nitrogen dioxide in the air sample from density and light extinction inside the optical cavity, wherein the processor determines the density inside the optical cavity from the digital signal generated by the detector, the pressure measured by the pressure sensor and the second temperature measured by second temperature sensor.
